(19) United States
(12) Patent Application Publication
(10) Pub. No.: US 2018/0359678 A1
(43) Pub. Date: Dec. 13, 2018

(54) MESH NETWORK ROUTING

(71) Applicant: Beartooth Radio, Inc., Bozeman, MT (US)

(72) Inventors: Jefferson M. Jones, Bozeman, MT (US); Michael C. Monaghan, Bozeman, MT (US)

(73) Assignee: Beartooth Radio, Inc.

(21) Appl. No.: 16/004,284

(22) Filed: Jun. 8, 2018

Related U.S. Application Data
(60) Provisional application No. 62/517,025, filed on Jun. 8, 2017.

(51) Int. Cl. H04W 40/12

(52) U.S. Cl. CPC H04W 40/12; H04W 84/18

(57) ABSTRACT

Mesh network routing methods and apparatus use link weights and node ranks to efficiently and quickly determine routes between source and destination nodes, with low consumption of computing resources and battery power. Link weights based on RSSI and SNR are suitable for wireless networks. Similar techniques based on analysis of analog link parameters extend the disclosed technologies to mesh networks on any medium.

### CROSS-REFERENCE TO RELATED APPLICATIONS

This application claims the benefit of U.S. Provisional Patent Application No. 62/517,025, entitled “MESH NETWORK ROUTING,” filed on Jun. 8, 2017, which is incorporated by reference herein in its entirety.

### FIELD

The present disclosure relates to routing in a mesh network.

### BACKGROUND

Some present solutions for mesh network routing are based on packet error rates or other packet statistics and can operate at a less then desirable speed , especially in environments where traffic levels are low. Such methods can work poorly, if at all, when network characteristics evolve faster than routing determinations can be made. Such methods can also suffer from excessive use of computing resources, which can be a significant disadvantage for battery-powered devices.

Other present solutions for mesh network routing rely on flooding data throughout a network, which unnecessarily uses bandwidth, radio power, and computing power, compared to the presently disclosed innovation, particularly where data payloads are large. Further solutions impose a defined structure on a network graph, so that a network whose graph looks like a mesh is managed as a structured network rather than a mesh network. Such solutions are intolerant of connectivity changes, require high maintenance, and are unsuitable for networks of mobile devices or devices that can be powered on or off.

Accordingly, there is a need for improved technologies to support mesh network routing.

### SUMMARY

In summary, the detailed description presents innovations in the art of mesh network routing that can be based on analog link measurements, and offer quick, low-power determination of good quality routing paths. The described innovations can also use small message packets for route establishment, and consequently can have a very light power footprint. Accordingly, computer resources in the form of storage, computing power, and computing time are reduced compared to conventional technology, and thus an improvement to the general and special purpose computer technology is achieved in examples of the disclosed technology.

The innovations can be implemented as part of one or more methods, as part of one or more computing systems adapted to perform an innovative method, or as part of non-transitory computer-readable media storing computer-executable instructions for causing a computing system to perform the innovative method(s). The various innovations can be used in combination or separately. The foregoing and other objects, features, and advantages of the presently disclosed innovation will become more apparent from the following detailed description, which proceeds with reference to the accompanying figures.

### BRIEF DESCRIPTION OF THE DRAWINGS

FIG. 1 is a diagram of a first method for packet routing according to the disclosed technologies.

FIG. 2 is a diagram of a mesh network depicting example analog signal measurements used in the disclosed technologies.

FIG. 3 is a flowchart of an example method for determination of link weights and node rank values according to the disclosed technologies.

FIG. 4 is a flowchart of an example method for determination and use of a routing path according to the disclosed technologies.

FIG. 5 is a diagram of a mesh network depicting example messaging for determination of a routing path according to the disclosed technologies.

FIG. 6 is a flowchart of an example method for determination of a routing path according to the disclosed technologies.

FIGS. 7A-7C illustrate further examples of mesh networks.

FIG. 8 is a block diagram of an example wireless device embodying the disclosed technology.

FIG. 9 is a block diagram schematically depicting a computing environment suitable for implementation of disclosed technologies.

### DESCRIPTION

### Overview

In mesh networks, nodes can frequently request routing information to maintain communication with nodes that are not adjacent to the requesting node. With conventional approaches, this can result in redundant route requests propagating throughout the network, which reduces overall network throughput, latency, and efficiency. Examples of the disclosed technology use link analysis based on analog properties of the link or channel to rank nodes. Following link analysis, lightweight messaging procedures can be used to probe for routing paths as needed. While some described examples are for wireless mesh networks, the technologies are not limited, and can be advantageously deployed or adapted in wired and optical networks.

As described herein, conventional techniques suffer from excessive utilization of computing and power resources, which is a challenging technical problem affecting the viability of practical wireless mobile mesh networks. Through the use of link analysis and node ranks, the disclosed technologies provide technical solutions for at least some aspects of this problem, in at least some applications.

### Terminology

### 1. Mesh Network

As used in this disclosure, a mesh network is a communication network comprising nodes coupled by links, whose management is unconstrained by the topology (or graph) of network connections. Some mesh networks have unconstrained topology, where connections between nodes can be formed at will, irrespective of other connections. Other mesh networks have physical constraints on node connectivity, e.g. due to number of ports or time slots available, due to a network medium limiting connections between distant nodes, or simply due to the finite number of nodes in the mesh network. Where the number of concurrent direct connections is limited, the limit is generally large, (e.g. 8 or more, or in the range 10-100, or higher), but can be as low as three.

An advantage of mesh networks is that they can provide multiple routing paths between pairs of nodes, which provides improved resiliency. Some mesh networks can have regular graphs, such as a hexagonal grid (each interior node connected to three neighbors), a square grid (each interior node connected to four neighbors), a hypercube (2N neighbors for an N-dimensional hypercube), or a fully connected mesh in which every node is directly connected to every other node. Other mesh networks can have irregular graphs, often containing one or more loops.

Mesh networks can be stationary or dynamic. As nodes join or leave a dynamic network, the network connectivity evolves. Dynamic wireless mesh networks can be formed of mobile nodes (or, a mix of mobile and stationary nodes) that reconfigure their connectivity as they move.

Because mesh networks have unconstrained topology, and can evolve, the specialized routing algorithms developed for structured networks comprising e.g. trees or rings are generally unsuitable, and a different class of routing procedures is required.

Some examples in this disclosure are directed to wireless mesh networks, which can include battery-powered mobile devices, for which connectivity can change frequently, and for which usage of power and computing resources are a particular concern. Connectivity changes can be triggered by changes in the physical environment (e.g. moving among buildings or mountains, or weather), by network devices moving (rapidly, in the case of vehicle-mounted devices), or by network devices changing state (power OFF, listen-only, periodic wakefulness, or power ON).

### 2. Acknowledgment

As used in this disclosure, the term Acknowledgment (ACK) is used to denote a protocol message confirming the existence or identification of a desired requested route. A Negative Acknowledgment (NAK) is used to denote a protocol message indicating inability to find the desired requested route. A NAK does not mean that the desired route is non-existent. As described herein, a NAK can lead to successful determination of the desired route by another path.

### 3. Device and Node

As used in this disclosure, the terms device and node are used synonymously to denote a hardware entity, often containing electronics and having computing functionality, that participates in a mesh network. The term device can be more commonly used where the context is the structure of the hardware entity, i.e. its constituent parts, while the term node can be more commonly used where the focus is on the network role of the hardware entity. Example nodes in wireless mesh networks can be realized as mobile radio, walkie-talkie, or base station types of devices. As used in this disclosure, mobile refers to any device that can be moved freely (unfettered by e.g. an extension cord) relative to a stationary terrestrial environment while in an operational state.

### 4. Forwarding

As used in this disclosure, the act of forwarding refers to receiving content in a message from one node and transmitting the received content to another node. In this disclosure, the forwarded message need not be identical to the received message, particularly since it is transmitted over a different link and can be expected to have different headers and encapsulation at the link layer, physical layer, or another layer.

### 5. Link

As used in this disclosure, a link is a point-to-point connection between two nodes of a mesh network. From the perspective of one of the linked nodes, an incoming link is the directional link received by that node from its partner node, while an outgoing link is the directional link transmitted by that node to its partner node. Together, the incoming and outgoing links comprise a bidirectional link between the two nodes. A link is a direct coupling between the two nodes, without any intermediary or relay nodes through which messages must pass. On a shared medium, such as in a wireless environment, a link can be a logical coupling at a link layer, and it is possible for a device to physically detect signals from nodes with which it is not linked.

### 6. Messages

As used in this disclosure, messages in a mesh network can be of two types. Protocol messages can be any communications that are part of the network communication protocol, at any layer, to maintain the network. Examples of protocol messages include route requests, ACK, NAK, power-up or power-down signaling, keep-alive messages, or messages for time slot allocation management. Payload or data messages can be messages that are carried by the network as a service to client applications, users, or other entities associated with one or more of the network devices. The payload or data message does not directly impact the operability of the network, however protocol messages can piggy-back on payload messages.

### 7. Neighbor

As used in this disclosure, any node having a direct link to a given node is a neighbor of the given node. Thus, a physically proximate device may not be a neighbor, while a physically distant device can be a neighbor. The terms “linked node” or “directly connected node” of a given node can be used equivalently.

### 8. RSSI

The term RSSI denotes received signal strength indication, and is a measure of the received signal power on a link, measured at the receiving device of the link. RSSI is commonly measured in logarithmic units, such as dBm.

### 9. SNR

The term SNR denotes signal to noise ratio, and is a measure of the detectability of a received signal on a link relative to noise on the transmission channel. SNR is also a measure of the reliability with which messages can be communicated over the link. SNR is commonly measured in logarithmic units, such as dB.

### First Example Method

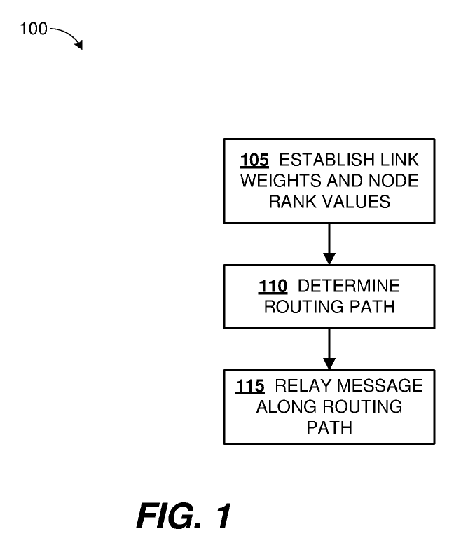

FIG. 1 is a diagram 100 of a first method for packet routing according to the disclosed technologies. This method can be deployed on a device in a mesh network, in collaboration with neighboring devices. At process block 105, the device determines link weights for its incoming links. In examples, the link weights are determined dependent on measured RSSI and SNR for each respective incoming link. Links with higher RSSI can be accorded higher link weights than links with lower RSSI. Links with higher SNR can be accorded higher link weights than links with lower SNR. Also at process block 105, node rank values can be determined for each node dependent on the link weights associated with that node. In examples, links with high link weights boost the node rank value of the receiving node of the link. Nodes with more incoming links of high link weight can receive higher node rank values and can be preferred for routing paths, because they can be considered better connected.

At process block 110, the node rank values can be used to determine one or more routing paths, as described further herein. In examples, the routing paths can be maintained in forwarding tables stored and maintained on the distributed nodes of the routing path. At process block 115, a routing path can be used to relay payload data, such as an application message or user message, along the routing path, from a source node to a destination node.

### Example Method for Determination of Link Weights

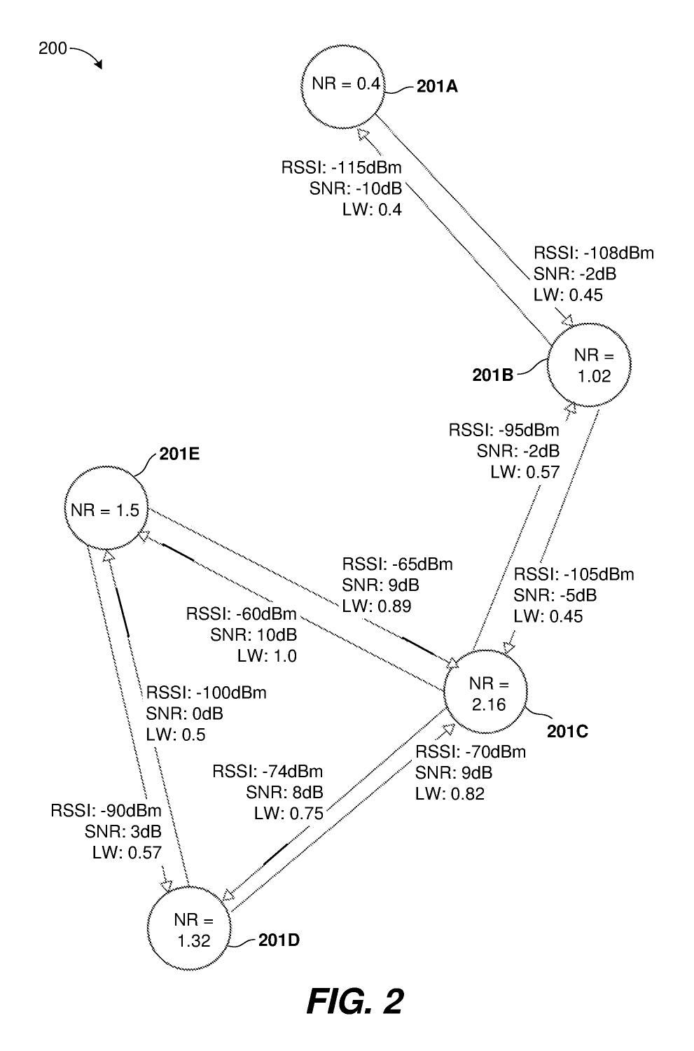

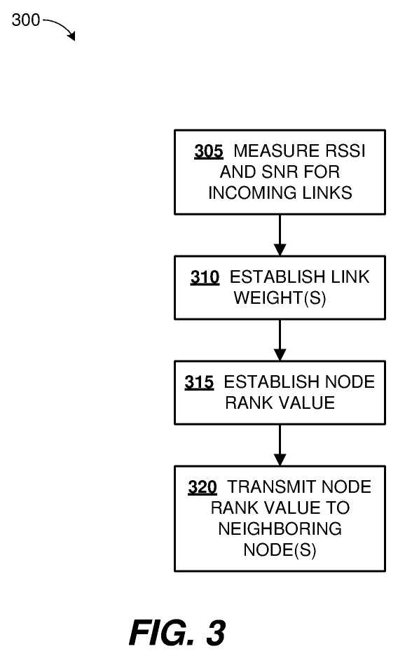

Determination of link weights can be used in a process for establishing routing in a wireless mesh network comprising a plurality of nodes coupled by a plurality of wireless links, and can be performed at a computing device in a mesh network, in collaboration with neighboring devices. This example will be described with references to FIGS. 2-3. FIG. 2 is a diagram of a mesh network 200 depicting example analog signal measurements used in the disclosed technologies. FIG. 3 is a flowchart 300 of an example method for determination of link weights and node rank values according to the disclosed technologies.

In FIG. 2, mesh network 200 comprises five nodes 201A-201E with links connecting neighboring node pairs 201A-201B, 201B-201C, 201C-201D, 201D-201E, and 201C-201E. Network 200 includes redundant paths, e.g. between nodes 201C-201D: there is a direct path 201C-201D, and an indirect path 201C-201E-201D.

At process block 305, the RSSI and SNR are measured for one or more incoming links of a network node. Example measurements are shown in FIG. 2, where node 201B receives a signal from node 201A having RSSI of −108 dBm and SNR of −2 dB as shown, and also receives a signal from node 201C having RSSI of −105 dBm and SNR of −5 dB. The signals from nodes 201A and 201C can be readily distinguished according to the time plan of network 200, i.e. nodes 201A and 201C transmit in different time slots and can be identified or isolated based on time slot. Measurement of RSSI and SNR are standard features of radio receivers, and as such, need not be described further herein.

At process block 310, link weights for respective links of each node can be determined. In examples, the link weight can be determined based on, or according to, a rule that depends on RSSI and SNR. The rule can be a monotonically increasing function of RSSI (for fixed SNR) or can be a monotonically increasing function of SNR (for fixed RSSI). In examples a function is used which is proportional to the sum of RSSI (e.g. measured in dBm) and SNR (e.g. measured in dB). Particularly, the formula can include clipping at one or both ends of the range to keep link weights within a practical dynamic range. As an example, link weight LW=50/MAX(50, (−RSSI[dBm]−SNR[dB])) can be used. Here, MAX(a, b) is a function returning the algebraically greater value among a or b. In examples, SNR can be positive or negative, while RSSI is often large and negative, often in the range −50 to −120 dBm. Since the numerical value of RSSI predominates, the formula can be simplified to LW=50/(MAX(|RSSI+SNR|, 50)). Clipping keeps the link weight to a maximum value of 1.0. The link weights for incoming links at all nodes are indicated as “LW” in FIG. 2. Other constants of proportionality or other monotonic functions of RSSI or of SNR can be used. As used in this disclosure, monotonically increasing is understood to mean non-decreasing, so that clipped functions can be considered monotonically increasing.

This method has been described in context of a single node, however as one of ordinary skill will readily appreciate from this description, the method can be carried out individually at some or all nodes of a network, e.g. when nodes power up, when other nodes power down, when link parameters change by more than a preset threshold, periodically or according to a schedule, or triggered responsive to a network condition such as route failure.

With this disclosure in hand, one of ordinary skill will recognize that many variations are possible. The above discussion is merely one example of a link analysis algorithm for determining link weights. Other attributes of signal quality, signal strength data, link congestion, or other signal parameters can also be used, and are not limited to wireless networks. Link weights can be used to determine routing paths in wired or optical mesh networks. The use of analog measurements (including radio link measurements) consumes less power than digital traffic measurements. The use of short messages for path finding consumes less computing power and less radio power than competing methods.

### Example Method for Determination of Node Rank Value

In this method, link weights can be used to determine node rank values. This example will also be described with references to FIGS. 2-3. At process block 315, node rank values are determined for each node of a network such as network 200 or another network similar to those disclosed herein.

In examples, the node rank value can be determined based on a rule of summing the link weights of all incoming links at any node. For example, at node 201B of FIG. 2, incoming links from nodes 201A and 201C have link weights of 0.45 and 0.57 respectively, so that the node rank (“NW”) value of node 201B is simply 0.45+0.57=1.02 as shown. FIG. 2 indicates the node rank values NR of each node according to this rule. The node rank values can be used to compare and rank nodes. For example, the neighbors of node 201C have NR=1.23 (node 201D), 1.50 (node 201E), and 1.02 (node 201B) respectively. Accordingly, among the neighbors of node 201C, node 201E has highest rank (NR=1.5) and node 201B has lowest rank (NR=1.02).

To facilitate such comparison, at process block 320, each node transmits its NR value to its link partners, i.e. to its neighboring nodes. Node 201B can maintain a node rank table of its neighbor nodes ranked according to their NR values. The NR value transmission can be performed during a transmission time slot allocated to the transmitting node. In examples, the time slot can be bootstrapped on power up.

Ranking is associated with the ability of nodes to reliably reach other nodes, directly or indirectly. Nodes with high RSSI and SNR have strong robust links that can provide reliable transmissions. Nodes with large numbers of neighboring nodes have better connectivity, making it more likely to find short, fast, and power-efficient routes via a node with high NR value. The combination of link analysis with node ranking allows the mesh network to prioritize high ranking nodes over lower ranking nodes when requesting a route to a non-adjacent node. That is, rather than transmitting a route request to all neighboring nodes, the route request can be transmitted to the highest ranking neighbor node only.

In examples, determination of link weights and node rank values can be performed while a node is in listen-only mode, i.e. without using precious battery capacity to perform transmissions. Particularly, a node can update its link weights or node rank in between successive ones of its transmission time slots.

Numerous variations are possible. Nodes can be ranked using a Page Rank algorithm, in which node ranks are based at least partly on the node ranks of the neighboring nodes. Node ranks of various sorts can be used to optimize routes for reliability and minimal hop counts. Thereby, the efficiency of mesh networks, including wireless mesh networks or ad-hoc mesh networks, can be substantially optimized.

### Example Method for Determination and Use of a Routing Path

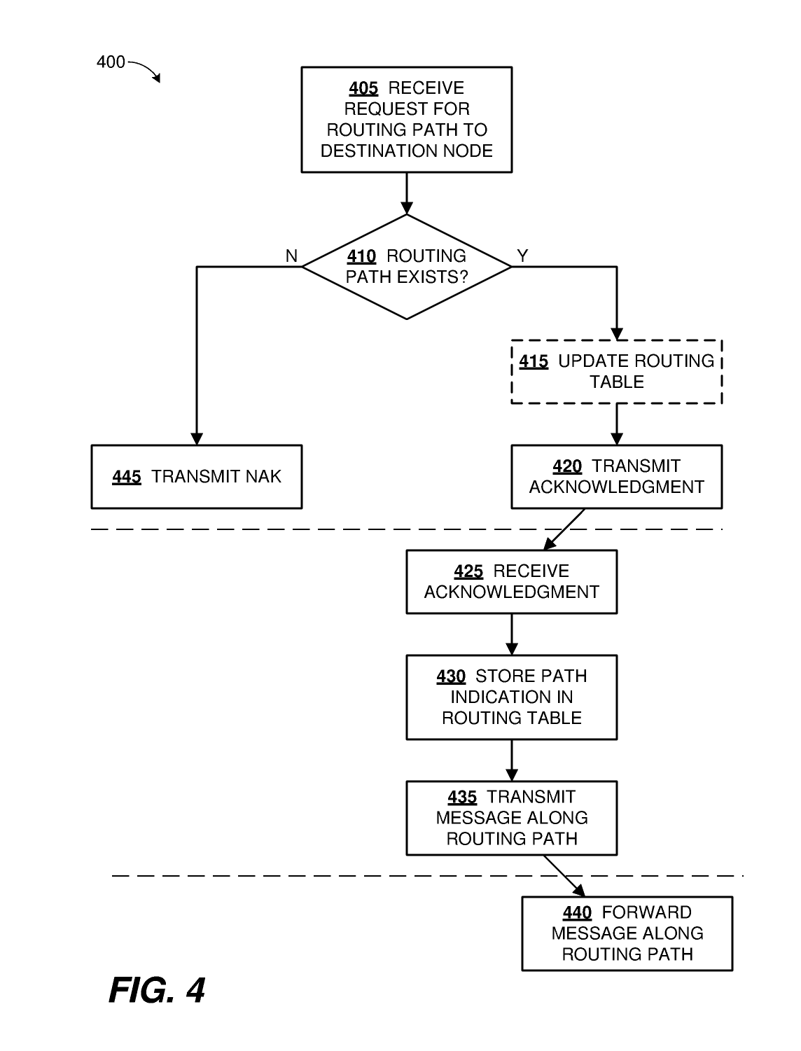

FIG. 4 is a flowchart 400 of an example method for determination and use of a routing path according to the disclosed technologies. This method is described in context of finding a route from a source node to a destination node via an intermediate node. Different aspects of the method can be performed at the intermediate node, and at an upstream node of the intermediate node. The upstream node can be an immediate upstream neighbor, which can also be the source node, or another upstream node in an attempted routing path.

At process block 405, the intermediate node receives a route request from the upstream node, seeking a path to a specified destination node. At process block 410, the intermediate node makes a determination whether there is a routing path from the intermediate node to the destination node. This determination can be made simply by checking the routing table at the intermediate node, if an entry for such a routing path exists, otherwise the determination can be made by recursive queries traversing (in examples, depth first) the mesh network downstream of the intermediate node, or as otherwise described herein. In examples, “downstream” merely means portions of the wireless mesh network that have not yet been investigated for the present route request.

If the determination at process block 410 is that a route exists, then the method follows the Y branch to process block 415 where (optionally) the routing table (also known as the forwarding table) at the intermediate node can be updated. In examples, the local routing table can be updated if the determination came through downstream requests to other nodes, and the local routing table need not be updated if the determination came from a pre-existing entry in the local routing table or if the determination came from a pre-existing entry in a connectivity table (i.e. the destination node is a neighbor of the intermediate node).

The method proceeds to process block 420, where an ACK is transmitted to the upstream node, responsive to the route request received at process block 405.

Process blocks 425-435 can be performed at the upstream node. The dashed line above process block 425 in FIG. 4 demarcates actions that can be performed at the intermediate node, from actions that can be performed at the upstream node. The ACK transmitted at process block 420 is received by the upstream node at process block 425. Because the ACK can incorporate an identifier of the sending node (i.e. the intermediate node), the upstream node can determine from the ACK that a routing path to the destination node exists through the intermediate node, and can update its forwarding table accordingly, at process block 430. Particularly, the upstream node can store a value in a routing table to indicate that a routing path to the destination node exists via the intermediate node.

Subsequently, at process block 435, the upstream node transmits a message or data packet, destined for the destination node, along the routing path using the updated entry in its forwarding table. That is the message or data packet can have an ultimate destination set equal to the destination node address, and a link destination set equal to the intermediate node address. The dashed line below process block 435 in FIG. 4 demarcates upstream node actions from intermediate node actions. At process block 440, the intermediate node receives the message or data packet transmitted at process block 435, and forwards it along the previously determined routing path, i.e. according to the routing table of the intermediate node.

### Example Determination of Routing Path

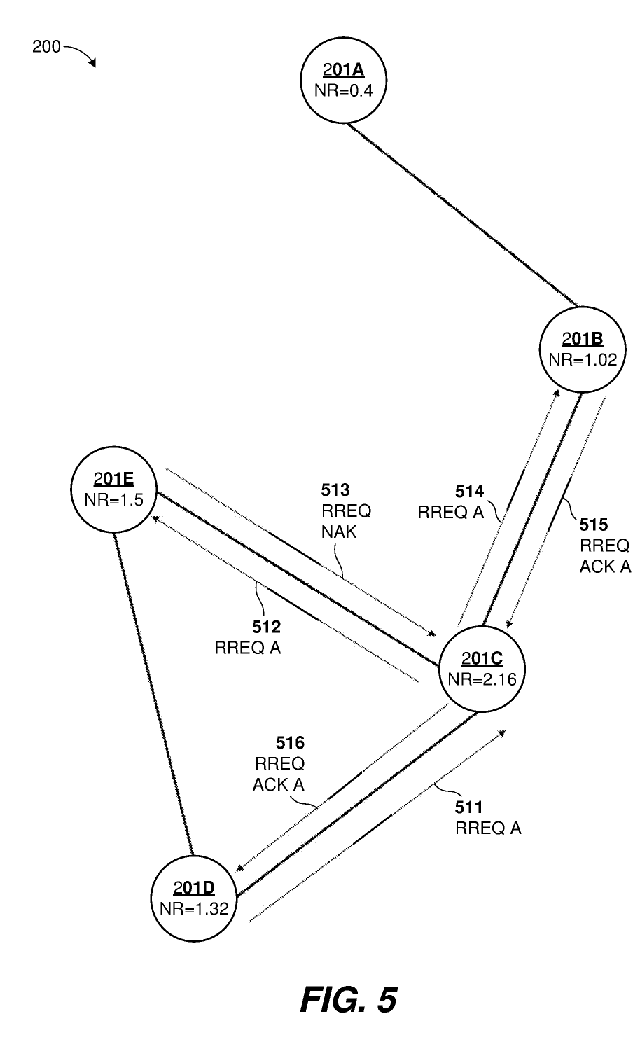

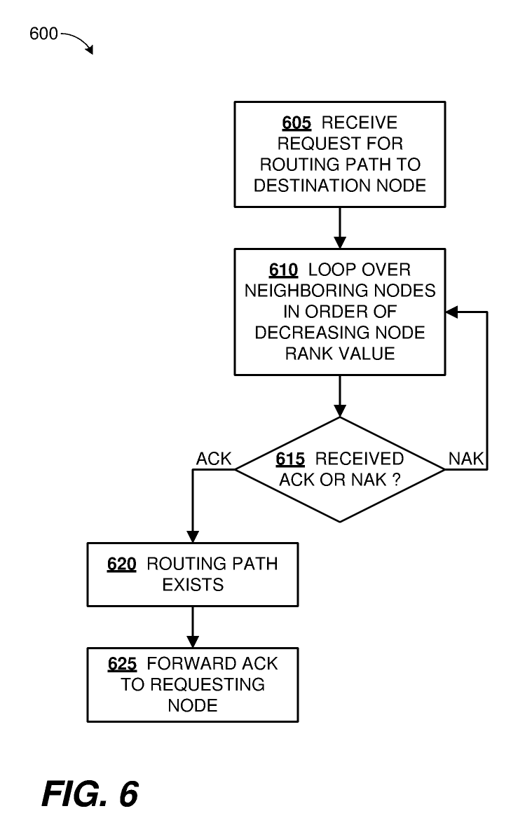

In examples, the node rank values can be used in a process for establishing routing in a wireless mesh network. This process can be performed at computing devices of nodes in a mesh network. This example will be described with references to FIGS. 5-6. FIG. 5 is a diagram of previously described mesh network 200 depicting example messaging for determination of a routing path according to the disclosed technologies. FIG. 6 is a flowchart 600 of an example method for determination of a routing path according to the disclosed technologies.

At process block 605, an intermediate node receives a request for a routing path to a destination node, similar to process block 405 discussed above. In the example of FIG. 5, intermediate node 201C receives a request 511 for a path to destination node 201A. Request 511 is accompanied by message shorthand “RREQ A” signifying a route request (“RREQ”) to destination node 201A (“A”).

As described herein, the intermediate node can maintain a node rank table indicating the NR values of its neighboring nodes. At process block 610, the intermediate node loops over its neighbor nodes in decreasing order of NR value. In the example of FIG. 5, node 201C forwards the request “RREQ A” as 512 to node 201E, which is the highest ranking neighbor of node 201C.

As will be explained shortly, node 201E cannot find a path to node A, hence 201E can return a NAK (negative acknowledgment) as 513 to node 201C. At process block 615, the method branches according to whether an ACK or NAK is received from the current neighbor node, presently node 201E. Following the NAK branch out of process block 615, the method returns to process block 610 to consider the next ranking neighbor node of the intermediate node, in this example node 201D. Because node 201D has already been traversed, there is nothing to do (not shown in FIG. 6), and the method skips to node 201B. (Had the NR values of nodes 201B and 201D been reversed, process block 610 would have gone directly from the NAK of node 201E to node 201B.) In any event, the NAK 513 from node 201E is followed by forwarding the “RREQ A” request as 514 to node 201B.

Because destination node 201A is a neighbor of node 201B, node 201B can directly return ACK A as 515 to node 201C, indicating that a path to node 201A is available and has been determined. Thus, at process block 615, the ACK branch is followed, and a determination is made at process block 620 that the desired routing path exists. Accordingly, at process block 625, the ACK A is forwarded by intermediate node 201C to its requesting node 201D, which is shown as 516 in FIG. 5. This completes the method.

### 1. Loop Avoidance

Because mesh networks often contain loops, it can be desirable to prevent wasteful redundant route request messages being sent to nodes that have already been explored for a current request. Different strategies are available to handle this, with varying tradeoffs between storage, latency, and messaging overhead.

In a first technique, a current partial path can be included within a route request message. In the example above, the route request message 512 can include “D” indicating that the current path includes node 201D (because node 201E receives message 512 from node 201C, “C” can be omitted from message 512). Thereby, node 201E can determine that sending a route request to node 201D would be redundant and wasteful, and can respond with NAK directly, since node 201E has no other neighbors.

In a second technique, the route request message can be encoded with an identifier unique to the route request (e.g. the route request from node 201D to node 201A). Then, node 201E can forward the route request to node 201D, and node 201D can recognize that the route request is one that it has already seen, and can respond immediately with a NAK.

In a third technique, the route request from node 201E to node 201D can be pre-empted by an advisory broadcast message from node 201D containing the route request identifier. That is, along with the original route request 511, node 201D can broadcast an advisory message containing the route request identifier so that its neighbor nodes (including node 201E) can determine that node 201D has already been searched for the identified route request, and that further route requests for the same identifier to node 201D would be redundant. Intermediate nodes can similarly broadcast an advisory message in turn. In varying examples, the advisory broadcast message can be implemented as a sequence of transmissions to each connected neighbor of the transmitting node, or as a true broadcast message to all receivers within range. In some examples on a shared medium, the route request itself can serve as the advisory broadcast message, so that node 201E can detect route request 511 and determine (from an embedded route request identifier) that there is an active route request for which node 201D has been searched, even though node 201E is not the recipient of message 511.

### Further Examples of Mesh Networks

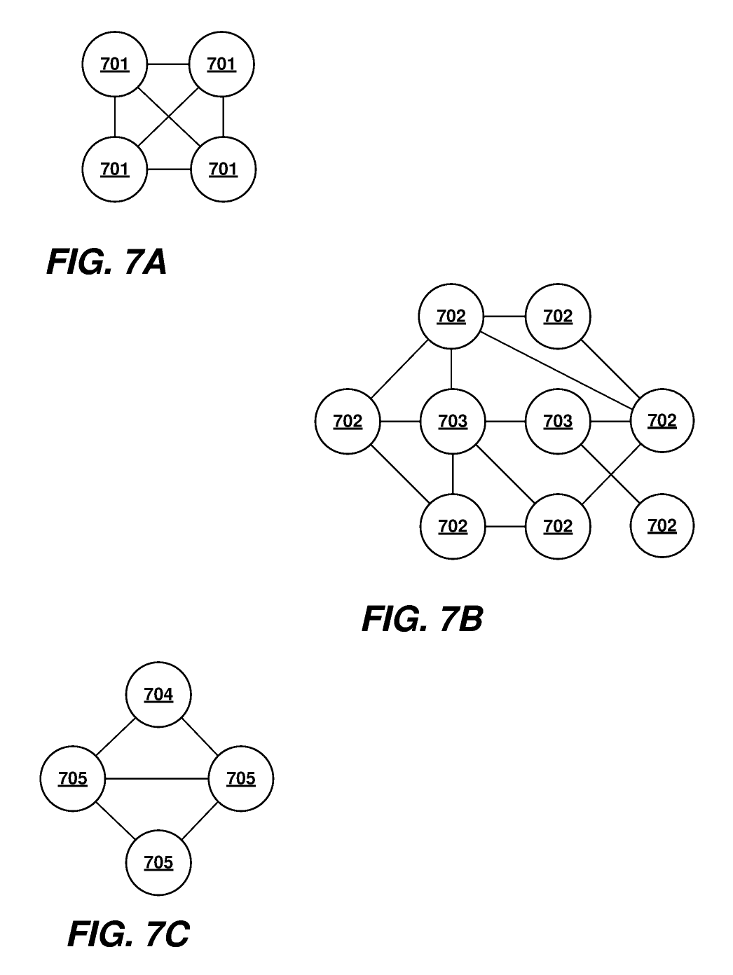

It will be understood that mesh network 200 is a simple network shown for illustrative purposes, and that the disclosed technology can be applied to a wide range of larger or more complex networks, having diverse features. FIGS. 7A-7C illustrate further examples of mesh networks to illustrate a few such diverse features. Embodiments having such features in any combination can advantageously implement the disclosed technologies. Of course, these features are merely exemplary, and none are requirements.

FIG. 7A illustrates a fully connected mesh network, comprising similar or functionally equivalent nodes 701, each of which is connected by a link to every other node 701. Such a mesh configuration can be applicable to some short range applications of e.g. walkie-talkie style devices, and to other applications of fixed stations in e.g. a mesh implementation of a campus Wi-Fi backbone or metro cellular backbone.

FIG. 7B illustrates a mesh network comprising a mix of node types 702, 703. The different node types can be different models of e.g. mobile phones, proprietary or standards-based radios, or walkie-talkie style devices. Alternatively, the different node types can be of different classes, for example nodes 702 can be portable hand-held or vehicle-mounted radios, while nodes 703 can be fixed stations or base stations.

FIG. 7C illustrates a mesh network in which similar devices 704, 705 are distinguished by role. For example, certain mesh network functionality can be delegated to a designated master node 704, while nodes 705 are not master nodes. For example, a master node can control time slot allocations of the network nodes. The disclosed technologies are applicable to both mesh network nodes having master nodes, and to fully distributed peer networks having no master nodes. Additionally, in some examples, the master node role can be migrated among member nodes over the lifetime of the mesh network.

### Example Mesh Network Device

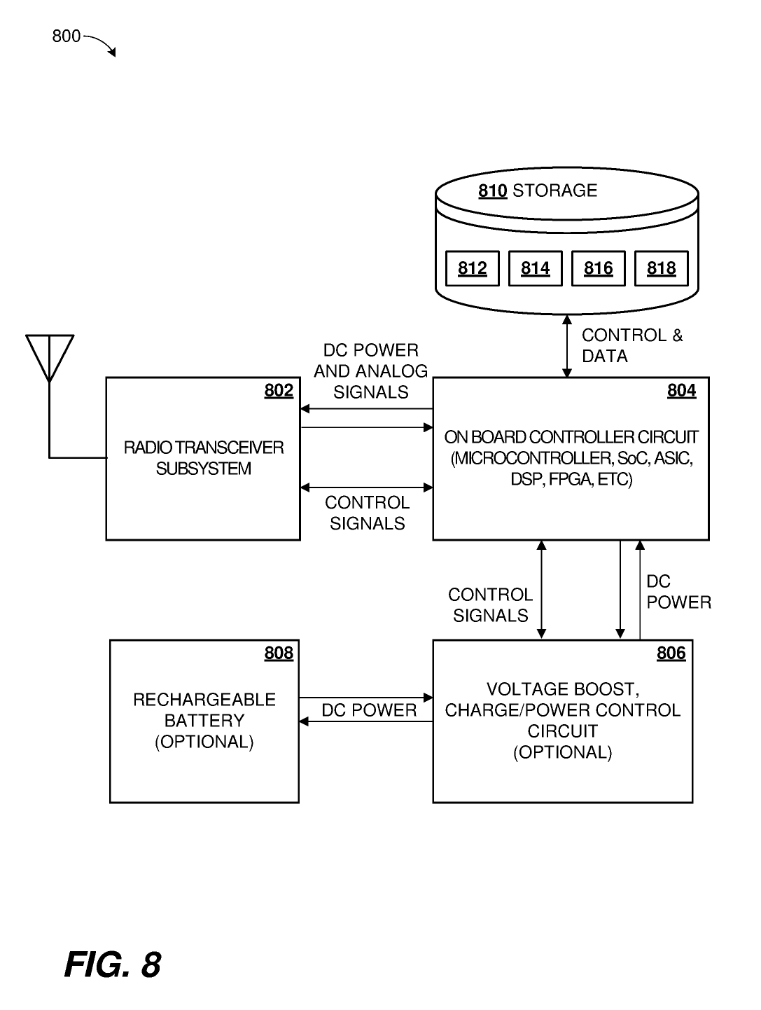

FIG. 8 is a block diagram of the electronic functional components of an example device 800 embodying the disclosed technology. An RF circuit 802 includes the circuitry necessary for long-range communication capabilities, as previously described. The RF circuit 802 interconnects to an onboard controller circuit 804 via DC power and analog signals as well as control signals, as indicated. The onboard controller circuit 804 can interconnect with voltage and power circuits 806, also via DC power and control signals as indicated. Finally, if a rechargeable battery 808 is further connected, it is interconnected with the voltage and charge system 806.

The controller 804 can incorporate one or more computer processors with memory coupled thereto and other such features as are described herein or are otherwise known in the art. In examples, the controller 804 can incorporate general purpose computer processors, or can incorporate special purpose processors such as radio SoC or ASICs which cannot be programmed with general purpose programming languages or tools. In some examples the controller 804 can partly or wholly be implemented as a commercial product such as a cellular telephone device. Even in examples where controller 804 incorporates general purpose computing components such as a processor or memory, the device 800 taken as a whole is a special purpose computer at least by virtue of its radio capabilities and its specialized embedded routing software or firmware functionality as described herein.

The example device 800 also includes a storage device 810, which can store as tangible physical storage elements various tables embodying the disclosed technologies. Neighbor table 812 can store parameters about network nodes that are neighbors of device 800, together with their respective node rank values. Link table 814 can store parameters about incoming links, such as analog signal measurements, such as RSSI and SNR. Forwarding or routing table 816 can store information about known paths. Table 818 represents other tables that can be used for e.g. intermediate storage during route finding, alerts during evolution of network environment or connectivity, or other mesh network attributes. Any one or more of tables 812-818 can also store operational attributes such as time-to-live (TTL) values as can be applicable to routing paths or time slots, or attributes associated with roles such as the network master.

### A Generalized Computer Environment

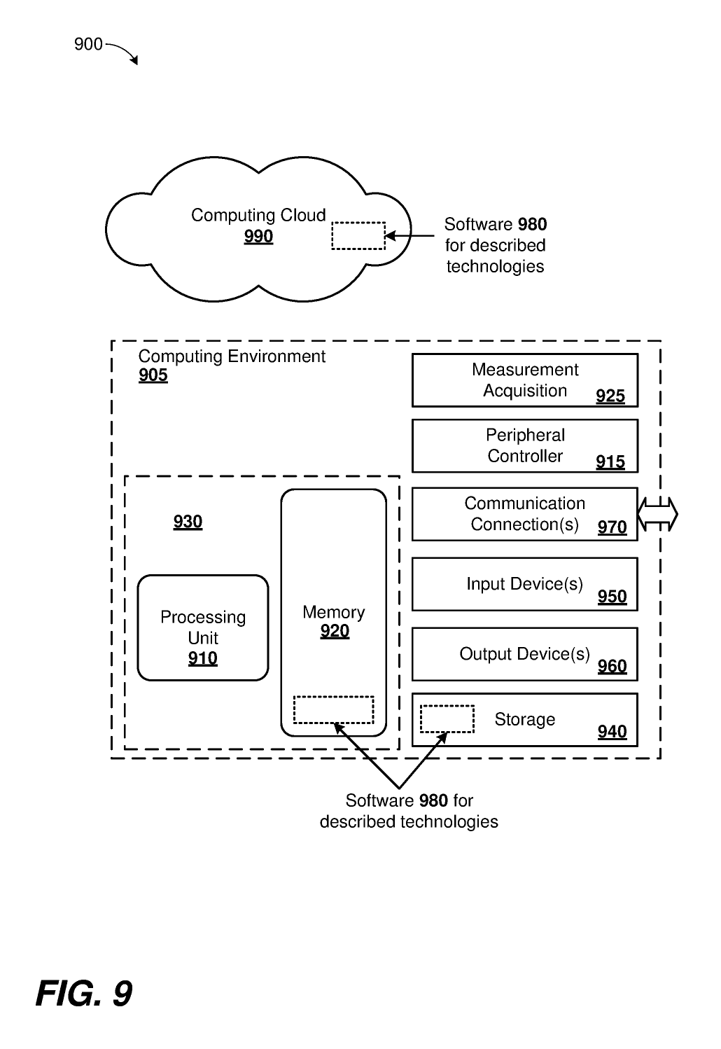

FIG. 9 illustrates a generalized example of a suitable computing system 900 in which described examples, techniques, and technologies, including construction, deployment, operation, and maintenance of a mesh network routing system can be implemented according to disclosed technologies. The computing system 900 is not intended to suggest any limitation as to scope of use or functionality of the present disclosure, as the innovations can be implemented in diverse general-purpose or special-purpose computing systems.

With reference to FIG. 9, computing environment 905 includes one or more processing units 910 and memory 920. In FIG. 9, this basic configuration 930 is included within a dashed line. Processing unit 910 executes computer-executable instructions, such as for implementing any of the methods or objects described herein for finding routes in a mesh network, making associated measurements, maintaining associated data structures, or performing other functions of the mesh network, or for implementing various other software entities described herein. Processing unit 910 can be a general-purpose central processing unit (CPU), a processor in an application-specific integrated circuit (ASIC), or any other type of processor. In a multi-processing system, multiple processing units execute computer-executable instructions to increase processing power. Computing environment 905 can also include a graphics processing unit or co-processing unit. Tangible memory 920 can be volatile memory (e.g., registers, cache, or RAM), non-volatile memory (e.g., ROM, EEPROM, or flash memory), or some combination thereof, accessible by processing units of the computing environment 905. The memory 920 stores software 980 implementing one or more innovations described herein, in the form of computer-executable instructions suitable for execution by the processing unit(s) 910. The memory 920 can also store configuration data, any of tables 812-818, buffers, identifiers, indices, data structures, or flags, as well as other configuration and operational data.

A computing system 905 can have additional features, such as one or more of storage 940, input devices 950, output devices 960, or communication ports 970. An interconnection mechanism (not shown) such as a bus, controller, or network interconnects the components of the computing environment 905. Typically, operating system software (not shown) provides an operating environment for other software executing in the computing environment 905, and coordinates activities of the components of the computing environment 905.

The tangible storage 940 can be removable or non-removable, and includes magnetic disks, magnetic tapes or cassettes, CD-ROMs, DVDs, or any other medium which can be used to store information in a non-transitory way and which can be accessed within the computing environment 905. The storage 940 stores instructions of the software 980 (including instructions and/or data) implementing one or more innovations described herein.

The input device(s) 950 can be a mechanical, touch-sensing, or proximity-sensing input device such as a keyboard, mouse, pen, touchscreen, trackball, a voice input device, a scanning device, or another device that provides input to the computing environment 905. The output device(s) 960 can be a display, printer, speaker, optical disk writer, or another device that provides output from the computing environment 905.

The communication port(s) 970 enable communication over a communication medium to another computing device. The communication medium conveys information such as computer-executable instructions or other data in a modulated data signal. A modulated data signal is a signal that has one or more of its characteristics set or changed in such a manner as to encode information in the signal. By way of example, and not limitation, communication media can use an electrical, optical, RF, acoustic, or other carrier.

In some examples, computer system 900 can also include a computing cloud 990 in which instructions implementing all or a portion of the disclosed technology are executed. Any combination of memory 920, storage 940, and computing cloud 990 can be used to store software instructions and data of the disclosed technologies.

The presently disclosed innovations can be described in the general context of computer-executable instructions, such as those included in program modules, being executed in a computing system on a target real or virtual processor. Generally, program modules or components include routines, programs, libraries, software objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

The terms “system,” “environment,” and “device” are used interchangeably herein. Unless the context clearly indicates otherwise, none of these terms implies any limitation on a type of computing system, computing environment, or computing device. In general, a computing system, computing environment, or computing device can be local or distributed, and can include any combination of special-purpose hardware and/or general-purpose hardware and/or virtualized hardware, together with software implementing the functionality described herein. Virtual processors, virtual hardware, and virtualized devices are ultimately embodied in one or another form of physical computer hardware.

### General Considerations

As used in this disclosure, the singular forms “a,” “an,” and “the” include the plural forms unless the context clearly dictates otherwise. Additionally, the terms “includes” and “incorporates” mean “comprises.” Further, the terms “coupled” or “attached” encompass mechanical, electrical, magnetic, optical, as well as other practical ways of coupling or linking items together, and does not exclude the presence of intermediate elements between the coupled items. Furthermore, as used herein, the terms “or” or “and/or” mean any one item or combination of items in the phrase.

Although the operations of some of the disclosed methods are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed things and methods can be used in conjunction with other things and methods. Additionally, the description sometimes uses terms like “access,” “apply,” “check,” “determine,” “explore,” “find,” “get,” “identify,” “learn,” “maintain,” “process,” “respond,” “search,” “update,” and “use” to indicate computer operations in a computer system. These terms denote actual operations that are performed by a computer. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions or a computer program product stored on one or more computer-readable storage media, such as tangible, non-transitory computer-readable storage media, and executed on a computing device (e.g., any available computing device, including tablets, smartphones, or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 9, computer-readable storage media include memory 920 and storage 940. The term computer-readable storage media does not include signals and carrier waves. In addition, the term computer-readable storage media does not include communication ports (e.g., 970) or communication media.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network, a cloud computing network, or other such network) using one or more network computers.

For clarity, only certain selected aspects of the software-based implementations are described. Other details that are known in the art are omitted. For example, it should be understood that the disclosed technology is not limited to any specific computer language or program. For instance, the disclosed technology can be implemented by software written in ABAP, Adobe Flash, C, C++, C#, Curl, Dart, Fortran, Java, JavaScript, Julia, Lisp, Matlab, Octave, Perl, Python, R, Ruby, SAS, SPSS, SQL, WebAssembly, any derivatives thereof, or any other suitable programming language, or, in some examples, markup languages such as HTML or XML, or in any combination of suitable languages, libraries, and packages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, infrared, and optical communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved. The technologies from any example can be combined with the technologies described in any one or more of the other examples.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method for establishing routing in a wireless mesh network comprising a plurality of nodes coupled by a plurality of wireless links, the method comprising:
by a respective processor at each node of the plurality of nodes:
establishing link weights corresponding to one or more incoming links of the node;
establishing a node rank value for the node based on the link weights; and
transmitting the node rank value to one or more neighboring nodes of the node.

2. The method of claim 1, wherein each of the link weights is determined by a rule that defines the link weight as a function of a received signal strength indication (RSSI) for the corresponding incoming link and of a signal-to-noise ratio (SNR) for the corresponding incoming link.

3. The method of claim 2, wherein the function is a monotonically increasing function of both the RSSI and the SNR.

4. The method of claim 3, wherein the function is proportional to a sum of the RSSI and SNR, both measured in logarithmic units, with clipping.

5. The method of claim 2, wherein the node rank value is established using a rule that defines the node rank value as a function summing the link weights.

6. The method of claim 1, further comprising:
at a first node of the plurality of nodes:
receiving, from a second node of the plurality of nodes, a route request for a path to a destination node of the plurality of nodes;
making a determination whether the first node has a first routing path to the destination node;
in at least a first case, responsive to the determination, transmitting an acknowledgment message to a second node that acknowledges existence of the first routing path;
at the second node:
responsive to receiving the acknowledgment message, storing a value in a routing table to indicate that a routing path to the destination node exists via the first node.

7. The method of claim 6, wherein making the determination further comprises:
forwarding the route request to a first neighboring node of the first node, the first neighboring node selected from among neighboring nodes of the first node based on the first neighboring node's node rank value;
wherein, in at least a first sub-case of the first case, transmitting the acknowledgment comprises forwarding a second acknowledgment received from the first neighboring node; and
in at least a second sub-case of the first case, forwarding the route request to a second neighboring node of the first node, responsive to receiving a negative acknowledgment from the first neighboring node.

8. The method of claim 7, wherein the first neighboring node has a highest node rank value among the neighboring nodes of the first node, and the second neighboring node has a next-highest node rank value among the neighboring nodes of the first node.

9. The method of claim 6, wherein at least one of the first node, the second node, and the destination node is mobile.

10. The method of claim 6, further comprising:
at the second node, transmitting to the first node a data packet addressed to the destination node;
at the first node, forwarding the data packet along the first routing path.

11. Computer-readable media storing instructions which, when executed by one or more processors at a node of a wireless mesh network, cause the processors to perform a method comprising:
establishing link weights corresponding to one or more incoming links of the node;
establishing a node rank value for the node based on the link weights; and
transmitting the node rank value to one or more neighboring nodes of the node.

12. The computer-readable media of claim 11, wherein each of the link weights is determined by a rule that defines the link weight as a function of a received signal strength indication (RSSI) for the corresponding incoming link and of a signal-to-noise ratio (SNR) for the corresponding incoming link.

13. The computer-readable media of claim 12, wherein the function is a monotonically increasing function of both the RSSI and the SNR.

14. The computer-readable media of claim 13, wherein the function is proportional to a sum of the RSSI and SNR, both measured in logarithmic units, with clipping.

15. The computer-readable media of claim 12, wherein the node rank value is established using a rule that defines the node rank value as a function summing the link weights.

16. The computer-readable media of claim 11, wherein the node is a first node and the method further comprises:
receiving, from a second node of the wireless mesh network, a route request for a path to a destination node of the wireless mesh network;
making a determination whether the first node has a first routing path to the destination node; and
in at least a first case, responsive to the determination:
transmitting an acknowledgment message to the second node that acknowledges existence of the first routing path; and
storing a value in a routing table to indicate that a routing path to the destination node exists.

17. The computer-readable media of claim 16, wherein making the determination further comprises:
forwarding the route request to a first neighboring node of the first node, the first neighboring node selected from among neighboring nodes of the first node based on the first neighboring node's node rank value;
wherein, in at least a first sub-case of the first case, transmitting the acknowledgment comprises forwarding a second acknowledgment received from the first neighboring node; and
in at least a second sub-case of the first case, forwarding the route request to a second neighboring node of the first node, responsive to receiving a negative acknowledgment from the first neighboring node.

18. The computer-readable media of claim 17, wherein the first neighboring node has a highest node rank value among the neighboring nodes of the first node, and the second neighboring node has a next-highest node rank value among the neighboring nodes of the first node.

19. The computer-readable media of claim 16, wherein at least one of the first node, the second node, and the destination node is mobile.

20. A system comprising:
a plurality of nodes coupled by a plurality of links to form a wireless mesh network; and
wherein each of the nodes is a node that comprises one or more computer processors with memory coupled thereto and that is configured to:
establish link weights corresponding to one or more incoming links of the node, wherein each link weight is determined according to a rule that is a monotonically increasing function of a received signal strength indication (RSSI) for the corresponding incoming link and of a signal-to-noise ratio (SNR) for the corresponding incoming link;
establish a node rank value for the node based at least partly on the link weights;
transmit the node rank value to one or more neighboring nodes of the node;
receive, from a first neighboring node of the neighboring nodes, a route request for a path to a destination node of the nodes;
determine whether the node has a first routing path to the destination node by:
forwarding the route request to a second neighboring node of the neighboring nodes, the second neighboring node selected from among the neighboring nodes based on having a highest node rank value among the neighboring nodes excluding the first neighboring node; and
in at least a first case, forwarding the route request to a third neighboring node of the neighboring nodes, responsive to receiving a negative acknowledgment from the second neighboring node;
responsive to the determination being that the node has a first routing path to the destination node, transmit a first acknowledgment message to the first neighboring node that acknowledges existence of the first routing path; and
forward a payload message subsequently received from the first neighboring node along the first routing path;
wherein, in respective cases, the transmitting the first acknowledgment message comprises forwarding a second acknowledgment message received from the second neighboring node or from the third neighboring node; and
wherein, responsive to receiving the first acknowledgment message, the first neighboring node is configured to store a value in a routing table to indicate that a routing path to the destination node exists via the node.
